(19) United States
(12) Patent Application Publication
(10) Pub. No.: US 2009/0135309 A1
(43) Pub. Date: May 28, 2009

(54) METHOD AND APPARATUS FOR SPEEDING UP ATSC CHANNEL SEARCHING

(75) Inventors: Martin DeGeorge, Cinnaminson, NJ (US); John Haiges, Jamison, PA (US); George Kulczyckyj, Richboro, PA (US)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/946,497

(22) Filed: Nov. 28, 2007

(51) Int. Cl. H04N 5/50

(52) U.S. Cl. 348/732; 348/E05.097

(57) ABSTRACT

A method of reducing channel scan time is achieved by knowing important location information such a zip code. This allows a locally stored database of available broadcast channels to be used to skip unused frequencies and to allow finding the direction of the most likely broadcast station. Once one active channel is located, it is possible to calculate the most likely direction to search for the remaining active channels in the data base using a smart antenna.

### FIELD OF THE INVENTION

The present invention relates to telecommunications, and in particular relates to a method and a corresponding apparatus for increasing the speed of channel scanning or discovery time for a receiver capable of receiving Advanced Television Systems Committee (ATSC), 8VSB, terrestrial broadcasts using a smart antenna. The invention provides in part a method and a apparatus for predicting the most likely direction to find other ATSC broadcasts after one such broadcast is located.

### BACKGROUND OF THE INVENTION

Digital television is just starting to make inroads into the viewing experience of users and today must coexist with over the air National Television System(s) Committee (NTSC) broadcasts as well. At this time, the number of digital over the air channels in any viewing area is small with the preponderance of broadcasts still in NTSC analog format. As a result, the digitally equipped television or set top box must scan every channel frequency and make a determination of the broadcast modality or if, indeed, a valid broadcast of any type is present. The time required to search each frequency can be rather extensive. If a smart antenna is used within the system, then for each channel, the receiver must search every antenna position or lobe and every antenna gain further increasing the search time. As a result, the channel search time can stretch into many tens of minutes, in some cases approaching one hour. For example, suppose that, on average, it takes about 5 seconds to discover, tune and lock each frequency setting. In actuality, this is a rather generous approximation as the dwell time on a frequency with no broadcast is typically longer. However, the channel search time was only for one channel, and only at one antenna position and one gain setting. As a result, the channel search time must be multiplied by the total number of channels, e.g. 68 channels, the total number of antenna positions, e.g. 16 antenna positions, and the total number of antenna gain settings, e.g. 4 gain settings. This results in a total search time of over 6 hours, clearly an unduly long and impractical time for initial channel discovery.

Traditionally, set top boxes and televisions have utilized a method of, first, scanning all channels for the existence of NTSC broadcasts and then not searching these frequencies for ATSC broadcasts. The reason is that NTSC acquisition is somewhat faster than that for ATSC. In the near future, however, this will be a moot point since NTSC will no longer be broadcast over the air.

The prior art also describes the use of databases to store channel information which is subsequently utilized for tuning. Many instances of using databases to store channel information exist in the literature but, in most cases, refer to receiving this information from some external location, for example the internet, and using the information stored in the database to attempt tuning of the channels based on the information contained in the database. However, the prior art does not describe pre-storing the database in local system memory, at the time of manufacturing, in order to increase channel searching efficiency. Accordingly, there is a need for a more effective method of pre-storing the database in local system memory, at the time of manufacturing, and there is a need for a more effective method of ATSC channel searching.

### SUMMARY OF THE INVENTION

In an effort to solve the foregoing needs, it is an objective of the present invention to provide a more effective method of ATSC channel searching and a more effective method of pre-storing a database contained in local system memory, at the time of manufacture of the ATSC receiver.

Accordingly, a first aspect of the invention relates to the generation of a database which contains lists of ATSC broadcast frequencies allocated by region, as well as contour maps of available RF power. The database is used to decrease channel searching times by eliminating channels that would normally be scanned by the receiver and having the receiver only scan the channels of the given region as identified in the database. The channels are eliminated if they are not located within the receiver's acceptable geographical area, as such channels would result in poor signal qualities, for example low signal to noise ratios. Thus, only the channels located within the receiver's acceptable geographical area will be scanned by the receiver and the channels not located within this geographical area will not be scanned. By using a stored database, a user can enter some localizing information, e.g. a zip code, which will allow the receiver to determine which ATSC channels are/not broadcasting in the local viewing area (i.e., the receiver can determine which ATSC channel's are within the receiver's acceptable geographical area). It is possible that the list of available broadcasting ATSC channels could be presented to the user for editing before a search is attempted. It is also possible that the database could be periodically updated from an external source such as the internet, input by the user, digital storage devices or other appropriate means. Also possible is the ability to update the channel list by the classical method of looking at all TV frequencies and, possibly, smart antenna settings during initial set up or while the unit is not being actively used for viewing. Importantly, however, each receiver will be able to determine the ATSC channels broadcasting in the acceptable geographical area based on the data contained in the database. It is noted that what constitutes an acceptable geographical area is determined by the equipment being utilized and the performance requirements of the given system, both of which will be determined on a system to system basis.

Additional aspects of this innovation are that given the channels in the viewing area and the direction in which some broadcast is located, for example using a multi-lobed antenna, it is possible to predict the most likely direction (e.g. which lobe to use) to search for the remaining broadcasts thereby further reducing the search time. For example, in the Philadelphia area, it is possible to receive ATSC broadcasts from Philadelphia, Trenton and Atlantic City. If the general location of the Philadelphia channel/station (for example, via postal zip code) is known and the Philadelphia channel is found, then it is possible to predict in which direction to search for (i.e. which lobe on a smart antenna to select to find) the Trenton and Atlantic City stations.

As a result of the present invention, the search times for ATSC channel searching can be dramatically reduced compared to prior art search methods.

Additional advantages of the present invention will become apparent to those skilled in the art from the following detailed description of exemplary embodiments of the present invention.

The invention itself, together with further objects and advantages, can be better understood by reference to the following detailed description and the accompanying drawings.

### BRIEF DESCRIPTION OF THE DRAWINGS

FIG. 1 illustrates an exemplary block diagram of one embodiment of the invention as used in a Digital TV (DTV) set top box.

FIG. 2a illustrates an exemplary flow chart of an exemplary embodiment of the antenna positioning algorithm.

FIG. 2b illustrates an example of the co-location phenomenon.

FIG. 3 illustrates an exemplary flow chart of an exemplary embodiment of the channel searching algorithm.

### DETAILED DESCRIPTION OF THE INVENTION

As explained in more detail below, the method and corresponding apparatus for increasing the speed of channel scanning or discovery time, for a receiver capable of receiving ATSC, 8VSB, terrestrial broadcasts using a smart antenna, is achieved by knowing location information of the smart antenna and/or receiver, for example, a postal zip code or latitude and longitude, as input by the user. In a given embodiment of the present invention, a locally stored database of available broadcast channels, for example, located within a certain distance from the input zip code, is created and utilized in order to identify the broadcast channels within the acceptable geographical area of the receiver, as well as to find the direction of the most suitable broadcast station. Once one active channel is located, using an ATSC receiver and a smart antenna, it is possible to calculate the most likely direction to search for the remaining active channels indicated to be in the acceptable area by the data pre-stored in the database. As a result, channel scanning time is significantly reduced.

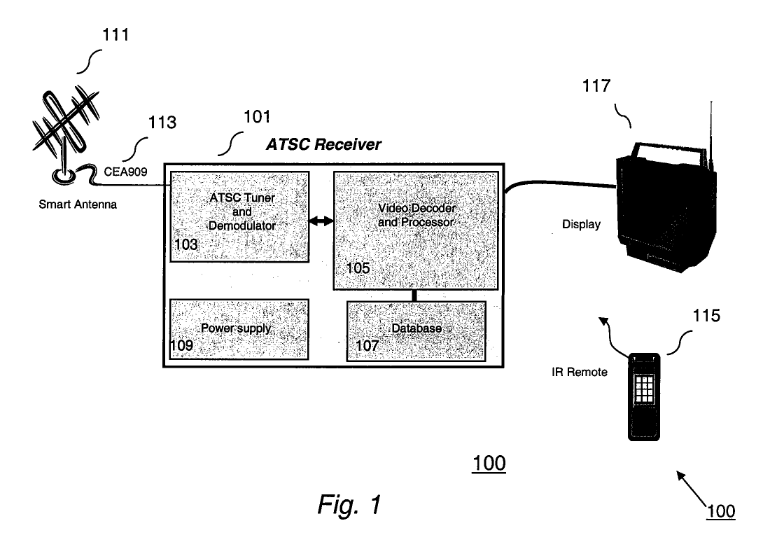

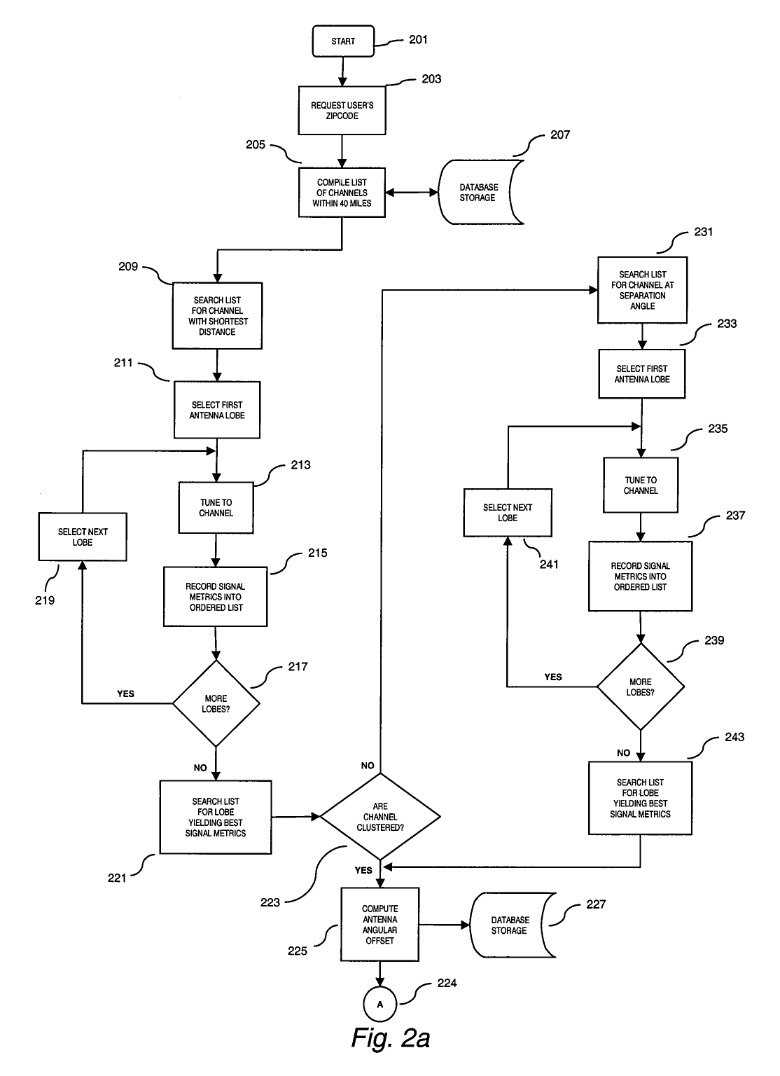

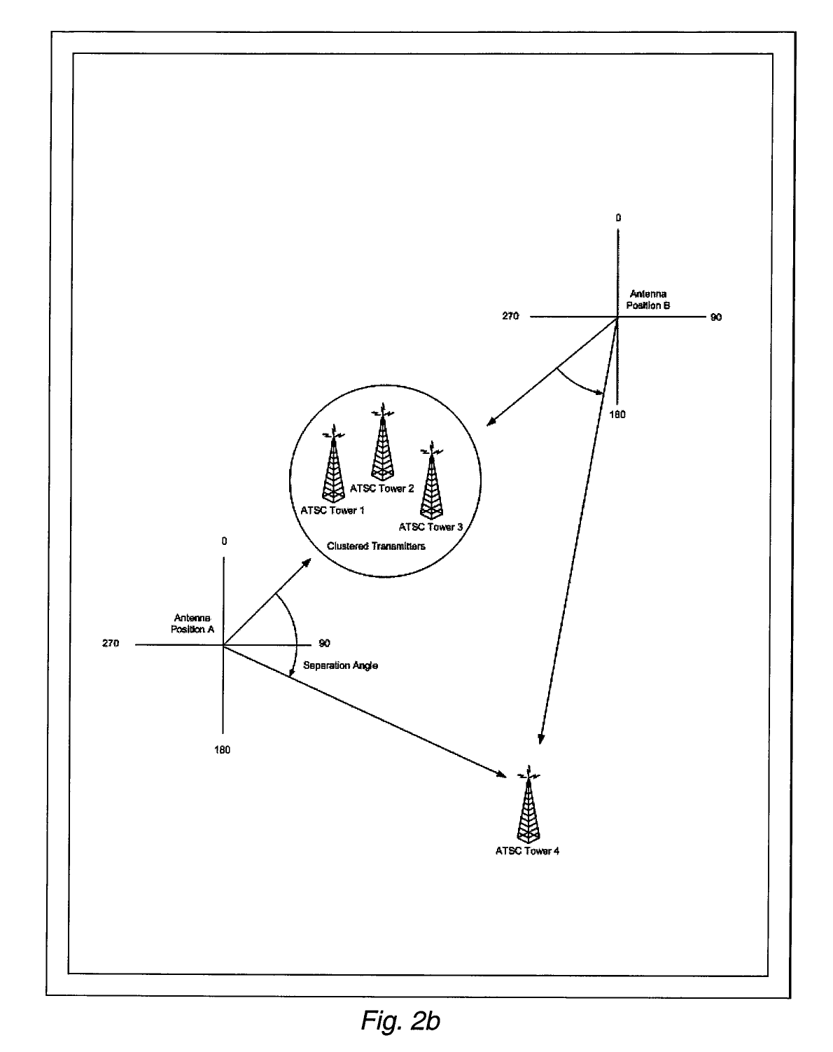

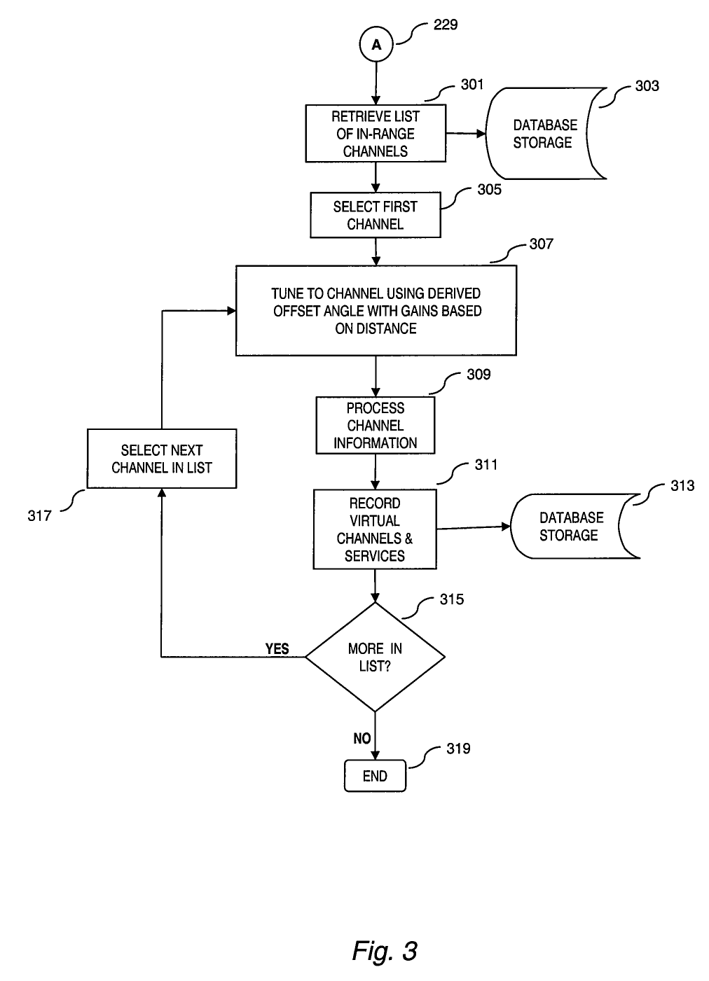

FIG. 1 illustrates an exemplary block diagram of one embodiment of the invention as used in a DTV set top box. Referring to FIG. 1, power supply 109 powers ATSC Receiver 101, which also includes ATSC Tuner and Demodulator 103, Video Decoder and Processor 105 and Database 107. When a user commands a channel scan, for example via the use of InfraRed (IR) Remote 115, Video Decoder and Processor 105 detects this command and requests the user, via Display 117, to input some location information, such as a postal Zip Code or latitude and longitude, indicating where the ATSC Receiver 101 and Smart Antenna 111 are located, via IR Remote 115. It is noted that the details of the antenna calibration and channel searching process or method are discussed below in FIGS. 2 and 3. Then, Video Decoder and Processor 105 uses this location information in conjunction with information stored in Database 107 to determine which ATSC (8VSB) channels are available for reception in the local area (i.e., which channels are within the receiver's acceptable geographical area). Typically, a local area is defined by a circle, having a predetermined radius, centered at a given location. The site of the radius can be manually selected by the operator or it can be preset; of course, other methods of defining the local area are also possible. In this embodiment, ATSC Receiver 101 contains a Database 107 of information pertaining to, for example, the input postal zip code. Additionally, for each zip code, Database 107 contains in-part: the approximate distance from the Smart Antenna, attached to the ATSC receiver, to the terrestrial broadcast tower, FCC regulated analog and digital TV channel numbers, frequencies of each channel, call signs of each channel, network names of each channel, compass orientation from degrees north of each terrestrial broadcast station, information regarding the broadcast power from each transmitter, etc. However, it is understood, that this is one embodiment of the invention, and that other embodiments exist. For example, postal Zip Code is selected here only for simplicity; other locating methods such as longitude and latitude can be substituted to determine the positioning of terrestrial broadcast towers. Furthermore, it is possible that a broadcast station list could be presented to the user for editing before a search for a broadcast station is attempted. It is also possible that Database 107 could be periodically updated from an external source such as the internet, any input by the user, digital storage devices or other appropriate methods. Also possible is the ability to update the channel list by the classical method of looking at all TV frequencies and, possibly, smart antenna settings during initial set up or while the unit is not being actively used for viewing. For the input zip code, the information stored in Database 107 is provided to the user via Display 117, as a channel list, for modification or acceptance with commands from IR Remote 115.

The channel list is then used to determine the proper frequencies which the ATSC Tuner and Demodulator 103 is directed to try to acquire. Smart Antenna 111 is connected to ATSC Receiver 101 via, for example, CEA909 113 antenna control interface. Smart Antenna 111 allows for directional reception of ATSC signals from all radial directions. During the tuning phase of operation, Smart Antenna 111 may be controlled by the CEA909 113 interface to search for the desired active channel by directing different antenna lobes in the direction of the expected signal. CEA909 113 interface is a standardized antenna control physical interface and control protocol. CEA909 113 interface employs a modular telephone-type connector with an offset latch using a six-conductor cable. The antenna direction and gain settings are sent by suitable commands from Video Decoder and Processor 105 to the antenna controller circuitry via the CEA909 113 interface. The channel searching process or method in FIG. 3 illustrates one embodiment of where the antenna gain settings are variably adjusted in the present invention.

Once one of the active broadcasts identified in Database 107 is detected by the receiver, the most likely direction for reception of the remaining channels may be calculated from the Antenna Angular Offset, discussed below and shown in the antenna orientation calibration algorithm of FIG. 2a.

When a user desires to initially utilize the ATSC receiver, the receiver will prompt the user to enter some sort of geographic location information, for example a postal zip code or latitude and longitude position of the receiver. The ATSC receiver will utilize this information and will utilize the antenna calibration process or method depicted in FIG. 2a for calibration purposes. Subsequently, the channel searching process or method in FIG. 3 will also be utilized in order to acquire the channels located in the corresponding geographic location. However, it is understood that this is one embodiment and that other embodiments are possible. For example, the user may want to update the system and/or perform another scan of the receiver to scan for newly available broadcasters in the area, wherein the methods illustrated in FIG. 2a and FIG. 3 will be utilized.

Referring to FIG. 2a, an example of an antenna orientation calibration process of the present invention is depicted. The antenna orientation calibration process orients the smart antenna by accounting for an angular phase difference between the antenna lobe expected to receive the best signal with the antenna lobe that actually receives the best signal. For example, the terrestrial broadcast tower locations are oriented from the directional compass positioning of North within ATSC receiver 101. The orientation of Smart Antenna 111 needs to be calibrated because, when the user defined location information is a postal zip code, this encompasses a broad area, and therefore ATSC receiver 101 does not know where within the postal zip code area it is located. Therefore, a received signal may be expected on the southwestern lobe of the antenna, but may actually be received on a northeastern lobe of the antenna. The antenna orientation calibration process accounts for this potential discrepancy via the Antenna Angular Offset in order to calibrate Smart Antenna 111. As a result, the position of the antenna lobe for each received channel will be shifted by the Antenna Angular Offset in order to correctly receive the ATSC signal.

The antenna orientation calibration method begins or starts at step 201, after which step 203 requests the user's Zip Code. For example, postal Zip Code is chosen here only for simplicity; other locating methods such as longitude and latitude positioning can be substituted to determine the positioning of terrestrial broadcast towers. Step 205 compiles a list of channels located within a predefined area, for example, 40 miles of the user's Zip Code from the Database at step 207. However, it is understood, that this is one embodiment of the invention, and that other embodiments exist. For example, the metric distance of 40 miles was chosen only for simplicity; and therefore other distances could be used when searching for available terrestrial broadcast channels. Step 209 searches the list of channels, located within 40 miles of the user's Zip Code, in order to locate the channel with the shortest distance from the user's Zip Code. Step 211 selects the first antenna lobe on the smart antenna. Step 213 tunes the ATSC receiver to the channel with the minimum geographical distance from the user's location. Step 215 records signal metrics into an ordered list. Step 217 determines if there are more lobes to scan on Smart Antenna 111. If the answer is yes, then the process or method proceeds to step 219. At step 219, the next Smart Antenna lobe is selected and the process or method returns to step 213, where steps 213 and 215 are repeated for each subsequent Smart Antenna lobe, for the channel that is located with the minimum geographical distance from the user's location. If the answer is no, then no more Smart Antenna lobes need to be scanned and the process or method proceeds to step 221. At step 221, the signal metrics for each Smart Antenna lobe are examined in order to find the Smart Antenna lobe that yielded the best signal metrics, for example best signal to noise ratio. Step 223 determines if the received terrestrial broadcast signals are clustered or co-located. In most densely populated areas, the television broadcast towers are closely located or clustered. Co-location means that the transmitters are, effectively, in the same transmitting tower and so once one is found, there is no need to look at any other lobes because the antenna orientation for all channels within the signal range is the same. If the answer at step 223 is yes, then the process or method proceeds to step 225 implying that the channels are clustered. If the answer is no, then the process or method proceeds to step 231; whereupon steps 231-243 are triggered. FIG. 2b illustrates the co-location phenomenon; a receiver-antenna may be located, relative to an ATSC broadcasting tower within signal range, in two or more possible locations. The positions of the receiver-antenna in FIG. 2b are noted by Antenna Position A and Antenna Position B. However, when the broadcast towers are positioned in multiple directions, then the direction of another broadcast tower must be determined by the search method or process in steps 231-243. In the first phase (steps 209-221), the closest tower from the receiver-antenna is discovered. However, the position of the receiver-antenna relative to this closest tower is unknown; only the direction from the receiver-antenna's position to that tower is known. As FIG. 2b illustrates, a receiver-antenna can be at Antenna Position A or Position B. To determine the receiver-antenna's relative position, another reference point is needed. At step 231, a broadcast channel is picked from the list compiled in step 205 that is “separated” from those broadcast towers that are “clustered”. The measure of “clustered” and “separated” is simply based on distances calculated by the antenna orientation calibration process of FIG. 2a, as it searches through the list compiled in step 205. Step 233 selects the first antenna lobe on the Smart Antenna. Step 235 tunes the ATSC receiver to the channel that is located in the different area or zone. Step 237 records signal metrics into an ordered list. Step 239 determines if there are more lobes to scan on the Smart Antenna. If the answer is yes, then the process or method proceeds to step 241. At step 241, the next Smart Antenna lobe is selected and the process or method returns to step 235, where steps 235 and 237 are repeated for each subsequent Smart Antenna lobe, for any channels located in the different area(s) or zone(s). If the answer is no, then no more Smart Antenna lobes need to be scanned and the process or method proceeds to step 243. At Step 243, the signal metrics, e.g. signal to noise ratio, for each Smart Antenna lobe are examined to find the lobe that yielded the best signal metrics. Once the direction from the receiver-antenna's position to the “separated” tower is discovered by steps 231-243, then the “separation angle” can be calculated. The method of position determination can be as simple as trial-and-error or by complex geometric calculations. In either case, the Separation Angle is calculated by Equation 1.

Equation 1→ The Separation Angle=the angular phase difference between the direction vectors resulting from the procedure in steps 209-221 and the direction vectors resulting from the procedure in steps 231-243

where, values are in degrees.

Afterwards, the process or method proceeds to step 225, where the Antenna Angular Offset is calculated. Afterwards, the process or method proceeds to step 225, where the Antenna Angular Offset is determined. Antenna Angular Offset is a calculated term which is then used to produce the positioning control signal sent by the ATSC receiver 101 to the Smart Antenna 111 via the CEA909 antenna control interface 113 in FIG. 1. The process of calculating the Antenna Angular Offset depends on whether the transmitting towers are clustered or separated, as determined by the processing steps above.

For the clustered or separated case, the receiver's position must be also determined. The method of position determination can be as simple as trial-and-error or by complex geometric calculations. In either case, the derived position must satisfy the requirement that the “separation angle” computed from the angular difference between the direction vectors resulting from the procedure steps 209-221 and procedure steps 231-243 must equal the “separation angle” of the same broadcast tower positions located within the map of the area constrained by step 205.

Once the position within the map of the area constrained by step 205 is known, the antenna can be pointed to any available tower on the stated map by retrieving the directional information stored in the database. However, the mounted orientation of the antenna must be determined because installers of Smart Antennas are not required to point the antenna to any specific compass direction. As a result, the 0 degree (compass North) orientations shown for Position A and Position B in FIG. 2b may be rotated. The computed Antenna Angular Offset must also compensate for any rotation due to the installed orientation. The rotational compensation angle is calculated by subtracting the actual direction of the broadcast tower determined by steps 209-221 from the stored database expected direction angle. For the clustered case, the Antenna Angular Offset for all transmitting towers within the area constrained by step 205 will be set to the antenna lobe direction that yielded the best signal metrics from step 221. The Antenna Angular Offset for each transmitting tower within a map of the area constrained by step 205 is stored in the Database at step 227.

Referring to FIG. 3, an exemplary channel searching algorithm process or method in accordance with the present invention is depicted. Video Decoder and Processor 105 performs the functions depicted in FIG. 3. While FIG. 3 illustrates a specific embodiment of the invention performed in Video and Decoder Processor 105, it is understood that other embodiments exist. Generally, the channel searching algorithm process searches the condensed ATSC channel list, based upon the information input by the user and accounted for in the antenna calibration process described in FIG. 2a, and attempts to acquire the signals on each expected channel using the correct antenna lobes. System specific parameters such as antenna gain and antenna direction, etc. are selected in order for ATSC Receiver 101 to operate optimally. The antenna direction and gain settings are sent by ATSC Receiver 101 to the antenna controller circuitry via the use of the CEA909 113 interface. The result is an immediate configuration of the proper antenna direction so that the tuner, within the receiver, can receive the expected signal (i.e., the signal can be readily acquired). Once the tuning process is locked onto the signal, the antenna directions and gains are continuously optimized in order to achieve the highest picture quality. Furthermore, a situation such as selecting the highest antenna gain setting for a channel that is only a few miles from the receiver will not be attempted. This will only result in a failed tune cycle because the resulting high level RF signal levels will overload the receiver tuning circuitry. Eliminating such invalid antenna gain settings also shortens the channel search algorithm times and optimizes the picture quality.

Unlike traditional analog television systems, ATSC digital broadcasts typically contain multiple audio/video streams which are referred to as “services.” For example, ATSC channel number 6 may carry three services: 6-1 Main program in high definition, 6-2 Main program in standard definition, and 6-3 Rebroadcast of the weather forecast. Moreover, the ATSC standard allows broadcasters to rename any of the services being transmitted to “virtual channels.” For example, Service 6-1 may become Channel 320. The discovery of available services and virtual channels is done as part of the scanning process by ATSC receivers when a channel map is constructed. A program may be tuned by “service” or by “virtual channel” number if available. Referring to FIG. 3, the exemplary method begins or starts at step 229 from FIG. 2a in order to record virtual channels and services. Step 301 retrieves a list of in-range broadcast channels from the Database at step 303. The Database at step 303 also provides the distance from the ATSC Receiver's Smart Antenna to the terrestrial broadcast tower. This distance is used to pre-select the appropriate antenna gain. Step 305 selects the first channel to be used in the channel searching algorithm. Step 307 tunes to the selected channel using the computed Antenna Angular Offset, from step 225 in FIG. 2a, with gains determined based upon the distance of the terrestrial broadcast tower from the ATSC receiver. Step 309 processes the channel information that is contained within the ATSC signal, for example, the information content contained within the digital channels; i.e. time information or any other data associated with the channel. However, it is understood, that this is one embodiment of the invention, and that other embodiments exist. Step 311 records virtual channels and services from the processing information in prior step 309. The recorded virtual channels and services are stored in the Database at step 313. Step 315 determines if there are more channels in the in-range broadcast channels list. If the answer is yes, then the process or method proceeds to step 317. At step 317, the next channel is selected from the in-range broadcast channels list and the process or method returns to step 307, where steps 307, 309, 311, and 313 are repeated for each subsequent channel in the in-range broadcast channels list. If the answer is no, then no more channels need to be scanned and the process or method proceeds to step 319, where the process or method ends. The final result is a method and a corresponding apparatus for speeding up channel scanning or discovery time for a receiver capable of receiving Advanced Television Systems Committee (ATSC), 8VSB, terrestrial broadcasts using a smart antenna. The invention provides a method and a corresponding apparatus for predicting the most likely direction to find other ATSC broadcasts after one such broadcast is located.

It is also noted that while the concepts disclosed herein may be used for ATSC receivers, it shall be understood that the disclosed concepts may be used with any type of communications systems, e.g. those used for NTSC/ATSC broadcast. For example, ATSC Receiver 101 allows the user to efficiently search channels expected to receive a signal and reduces the channel searching time and automates the process of searching for channels in any type of broadcast communications system. Additionally, ATSC Receiver 101 does not require the user to reposition the antenna/s, allowing for transparent viewer use.

Although certain specific embodiments of the present invention have been disclosed, it is noted that the present invention may be embodied in other forms without departing from the spirit or essential characteristics thereof. The present embodiments are therefore to be considered in all respects as illustrative and not restrictive, the scope of the invention being indicated by the appended claims, and all changes that come within the meaning and range of equivalency of the claims are therefore intended to be embraced therein.

We claim:

1. A method of searching for channels between a terrestrial broadcast location and an antenna, said method comprising the steps of:
compiling a list of channels and the respective terrestrial broadcast location of each channel within a predetermined distance of an inputted geographical position of the antenna; and
determining a channel from the list having a shortest distance between the antenna and the respective broadcast location.

2. The method according to claim 1, further comprising the steps of:
(a) selecting an antenna lobe;
(b) tuning to the channel from the list having a shortest distance;
(c) recording a signal metric into an ordered list.

3. The method according to claim 2, further comprising the steps of repeating steps (a), (b) and (c) for a plurality of lobes until signal metrics have been recorded for all lobes.

4. The method according to claim 3, further comprising the step of searching the ordered list for the lobe yielding a best signal metric.

5. The method according to claim 1, further comprising the step of determining that the compiled channels are not located in a similar geographical region.

6. The method according to claim 5, further comprising the steps of:
(a) searching the list for the corresponding channel not located in the similar geographic region and at a separation angle;
(b) selecting an antenna lobe;
(c) tuning to the corresponding channel not located in the similar geographic region and at the separation angle;
(d) recording a signal metric into an ordered list.

7. The method according to claim 6, further comprising the steps of repeating steps (a), (b), (c) and (d) for a plurality of lobes until signal metrics have been recorded for all lobes.

8. The method according to claim 7, further comprising the step of searching the ordered list for the lobe yielding a predetermined best signal metrics.

9. The method according to claim 1, further comprising the step of computing an antenna angular offset for each channel relative to the channel having the shortest geographical distance.

10. The method according to claim 8, further comprising the step of computing an antenna angular offset for each channel relative to the channel having the shortest geographical distance.

11. The method according to claim 9, further comprising the steps of
(a) retrieving the list of channels
(b) selecting a channel;
(c) tuning to the channel from the list using the corresponding offset angle and a receiver gain based on the distance between the antenna and the respective broadcast location; and
(d) recording virtual channels and corresponding services into an ordered list.

12. The method according to claim 11, further comprising the steps of repeating steps (a), (b), (c) and (d) for a plurality of channels until virtual channels and corresponding services have been recorded for all compiled list of channels.

13. The method according to claim 1, wherein said inputted geographical position of the antenna is a postal zip code.

14. The method according to claim 1, wherein said inputted geographical position of the antenna is a latitude and a longitude.

15. A communications receiver comprising:
a tuner for receiving a signal transmitted from a terrestrial broadcast location;
a demodulator for demodulating a signal;
a video decoder for formatting the received signal on a display device;
a microprocessor configured to perform a search of channels between a terrestrial broadcast location and an antenna, wherein said search of channels comprises the steps of:
(a) compiling a list of channels and the respective terrestrial broadcast-location of each channel within a predetermined distance of an inputted geographical position of the antenna; and
(b) determining a channel from the list having a shortest distance between the antenna and the respective broadcast location.

16. The receiver according to claim 14, further comprising a received signal, wherein said signal is received from a smart antenna.

17. The receiver according to claim 14, further comprising a database, wherein said database comprises a list of channels.

18. The receiver according to claim 16, wherein said list of channels is comprised of a master list.
